(19) United States
(12) Patent Application Publication
(10) Pub. No.: US 2009/0320794 A1
(43) Pub. Date: Dec. 31, 2009

(54) Novel Internal Combustion Torroidal Engine

(76) Inventor: Nicholas Mirabile, North Richland Hills, TX (US)

Correspondence Address: Lynn E Barber, P.O. Box 16528, Fort Worth, TX, 76162, US

(21) Appl. No.: 12/223,365

(22) PCT Filed: Feb. 22, 2005
(86) PCT No.: PCT/US2005/005539

§ 371 Date: Jul. 28, 2008

Related U.S. Application Data
(63) Continuation of application No. 06/546,577, filed on Oct. 28, 1983, now Pat. No. 4,710,556.

(51) Int. Cl. F02B 57/08

(52) U.S. Cl. 123/44 E

(57) ABSTRACT

A novel combustion engine is disclosed that is also called the Mirabile engine (10). The Mirabile engine (10) comprises an air intake (18), an air compressor (22), coupled to the air intake (18), and a combustion chamber (24), coupled to the air compressor (22). A shuttle valve (50) is included and is placed between the air compressor (22) and the combustion chamber (24) to seal off the combustion chamber from the air compressor during combustion. The engine (10) includes a fuel supplier (70), coupled to the air compressor (22) and the combustion chamber (24), to deliver fuel to the air after intake to provide a fuel/air mixture that has been compressed within the combustion chamber (24). The invention further comprises a crank shaft (46), rotatably coupled to the air compressor (22) to operate the air compressor and to transfer power generated by the engine (10) to a useful purpose. A turbine piston (12) is also included, which is coaxially coupled to the crank shaft, and travels in a circular path. The turbine piston (12) travels adjacent to the combustion chamber (24) and serves to seal the combustion chamber (24) during combustion of an air/fuel mixture and opens to be driven by a force generated by combustion of the fuel/air mixture within the combustion chamber as the combusted fuel/air mixture escape and is directed against the turbine piston (12) to rotate the turbine piston and turn the crank shaft. Additional compression chamber and combustion chamber pairs can be added to increase the power of the Mirabile engine.

This patent application claims priority on U.S. Provisional Patent Application No. 60/546,577 filed Feb. 20, 2004, entitled “A NOVEL INTERNAL COMBUSTION TURBINE ENGINE,” and on U.S. patent application Ser. No. ______ (Client Reference Mirabile 0003), filed Dec. 11, 2004, entitled “A NOVEL INTERNAL COMBUSTION TORROIDAL ENGINE,” both invented by Nicholas F. Mirabile, herein incorporated by reference for all purposes.

### BACKGROUND

The present invention relates to internal combustion engines, namely, to an engine that isolates the combustion chamber from a compression chamber and directs the combusted fuel mixture tangentially against a drive wheel.

There are many types of engines that have been developed over the past 250 years. The evolution of engines began with steam engines, which were an external combustion engine, but were dangerous and inefficient Stirling engines were developed because of the danger of the early steam engines. Stirling engines are still used where quiet operation is greatly desired. They too are external combustion engines. Next came internal combustion engines. These include two stoke gasoline and diesel engines, four stroke gasoline and diesel engines, and turbine engines.

Two stroke engines are the engine of choice for limited use with great power production. They are simpler than four stroke engines, such as those found in automobiles, because of the lack of valves. Further, two stroke engines fire every revolution as opposed to once every other revolution compared to four stroke engines. Two stroke engines can work in any orientation, which is advantageous in applications, such as garden or yard tools like an eager or chain saw. A four stroke engine, by contrast, uses oil for lubricating the crank shaft and pistons and managing the oil flow could be troublesome and add to the complexity of the engine to solve this problem.

Unfortunately, two stroke gasoline engines have several problems as compared to a four stroke gasoline engine. One is that the compression of the air-fuel mixture causes leaking past the cylinder out the exhaust port during each cycle. This leaking is an environmental hazard. Further, two stroke engines do not last as long as a four stroke engine. The lack of a dedicated lubrication system means that the parts of a two stroke engine wear a lot faster than those in a four stroke engine. Further, two stroke engine oil, mixed with the fuel to provide lubrication, is expensive and is consumed at a rate of about one gallon for every 1,000 miles if used as a car engine. Lastly, two stroke engines are less efficient man four stroke engines, so fuel economy would suffer.

A two stroke diesel engine, by contrast, which only compresses air and then injects the fuel directly into the compressed air, is a much better match with the two stroke cycle. This is the engine of choice in large diesel engines, such as those used in heavy machinery, ships, and locomotives.

The diesel engine often utilizes a turbocharger or supercharger to fill the chamber with air prior to the compression step then subsequent fuel injection/combustion step. The forced air into the chamber clears out the burnt fuel exhaust out an exhaust port normally found on the opposite wall of the chamber from that of the intake valve. This design lends itself to large engine applications and is riot practical for small engine applications, such as for applications of a gasoline two-stroke or four stroke engine.

A reciprocating internal combustion engine is the engine of choice for mass transit as it is relatively efficient compared to external combustion engines, is relatively inexpensive to build, as compared to gas turbine engines, and relatively easy to refuel, as compared to electric cars. The standard internal combustion engine uses a four stroke cycle that includes, drawing in a fuel air mixture, compression of that mixture, ignition and rapid expansion, then exhausting of the spent fuel exhaust before the cycle repeats. The engine can be cooled internally, via a radiator coolant system, to prolong life and efficiency, or it can be air cooled, utilizing radiating fins.

The four stroke engine can be very efficient, but it loses power as compared to a two stroke engine since twice as many steps must be performed, meaning that only one combustion for every two revolutions can occur. A four stroke diesel engine operates much as a gas engine does, except it relies upon a higher compression of the air, with no fuel mixed prior to compression and then added just before combustion due to the high pressure. The higher the pressure, the greater the power released during the combustion stage. An exhaust step occurs after combustion prior to beginning again and drawing a new supply of air to compress. Since the fuel is added just before combustion, a higher air compression can be achieved, resulting in higher power output for the same cylinder displacement of that of a gas engine.

In a gas turbine, a pressurized gas spins the turbine. In all modern gas turbine engines, the engine produces its own pressurized gas, and it does this by burning something like propane, natural gas, kerosene or jet fuel. The heat that comes from burning the fuel expands air, and the high-speed rush of this hot air spins the turbine. Gas turbine engines have a great power to weight ratio as compared to reciprocating engines. Gas turbine engines also are smaller than their reciprocating counter parts of the same power. Gas turbine engines utilize a compressor to compress incoming air to a high pressure, a combustion area, to burn the fuel and produce high pressure, high velocity gas, and a turbine, to extract the energy from the high pressure, high velocity gas flowing from the combustion chamber.

The main disadvantage of gas turbines is that, compared to a reciprocating engine of the same size, they are expensive. They spin at such high speeds and such high temperatures that designing and manufacturing gas turbines is very difficult from an engineering and materials perspective. Gas turbines also tend to use more fuel when they are idling, and they prefer constant rather than a fluctuating load. This explains why they are more suited for aircraft use and not for conventional automobiles, although military applications have led to the use of a gas turbine in tanks.

What is needed is an efficient internal combustion engine that avoids the environmental limitations of a conventional two stroke gasoline engine. Further, what is needed is an efficient internal combustion engine that optimizes power output with respect to the direction of force to turn a drive shaft Further still, what is needed is an efficient internal combustion engine that can be compact saves fuel, and optimizes power over that of the prior art.

### SUMMARY OF THE INVENTION

According to the present invention, a novel combustion engine is disclosed also called the Mirabile engine. The Mirabile engine comprises an air intake, an air compressor, coupled to the air intake, a combustion chamber, coupled to the air compressor, a shuttle valve, placed between the air compressor and the combustion chamber, to seal off the combustion chamber from the air compressor during combustion, a fuel supplier, coupled to the air compressor and the combustion chamber, that delivers fuel to the air after intake to provide a fuel/air mixture that has been compressed within the combustion chamber, a crank shaft, rotatably coupled to the air compressor to operate the air compressor and to transfer power generated by the engine to a useful purpose, a turbine piston, coaxially coupled to the crank shaft, that travels in a circular path and is adjacent to the combustion chamber and serves to seal the combustion chamber during combustion of an air/fuel mixture and opens to be driven by a force generated by combustion of the fuel/air mixture within the combustion chamber as the combusted fuel/air mixture escape and is directed against the turbine piston to rotate the turbine piston and turn the crank shaft.

The combustion engine utilizes an air compressor having a reciprocating piston within a compression chamber that draws air through the air intake and compresses the air into the combustion chamber separate from the compression chamber. The combustion engine also has fuel injected either into the compression chamber prior to compression or within the combustion chamber prior to combustion to form the fuel air mixture. The Mirable engine operates similar to a classic two cycle engine being gasoline or diesel.

The fuel can be, but is not limited to, gasoline, diesel, propane, natural gas, kerosene, jet fuel. In the event that gasoline or other flammable fuels are consumed, a spark plug is utilized as an igniting element or ignitor. Should the engine use diesel or other fuels that can combust at sufficient enough pressure, no ignitor is necessary other than achieving the high pressure necessary to cause combustion. During cold weather, since pressure is proportional to heat and the compression chamber may be too cold for the pressure to cause combustion, a glow plug can be included to begin the combustion cycle until the engine warms enough to spontaneously bring about combustion.

The engine includes a second combustion chamber and compression chamber aligned opposed to the first compression chamber and combustion chamber and within a common plane such that the engine can provide two combustion cycles per rotation of the turbine piston. Additional opposing compression chambers and combustion chamber arrangements can be included, with one shifted 90 degrees to the orientation of the first set of opposing compression pistons, resulting in four combustions per turbine piston revolution.

The Mirable engine operates according to die method steps as follows: deriving power within a combustion engine having a turbine piston by intaking air; compressing the intake air within a first compression chamber using a compression piston; shuttling the compressed air to a first combustion chamber separate from the compression chamber; injecting fuel within the intake air; sealing the first combustion chamber from the first compression chamber; sealing the first combustion chamber with a portion of the turbine piston as it rotates about a piston head trace adjacent the first combustion chamber, igniting the compressed fuel/air mixture within the sealed first combustion chamber to combust the fuel/air mixture; removing the turbine piston seal, allowing the combusted fuel/air gases to escape towards the turbine piston and impart its moment to the turbine piston increasing its rotation momentum; and repeating these steps thereby deriving power from the combustion events within the first combustion chamber.

The method further operates such that a second compression chamber and second combustion chamber are located on an opposite side of the path of the turbine piston as compared to the first compression chamber and second combustion chamber such that the steps as performed by the second compression chamber and second combustion chamber operate 180 degrees out of phase of same steps as performed by the first compression chamber and the first combustion chamber resulting in two combustion events per revolution of the turbine piston.

The method has the turbine piston connected to a crank shaft, which is further coupled to the compression piston to perform the compression step further comprising the step of transferring power from the turbine piston to the crank shaft.

These and other features of the present invention will be understood upon the reading of the following description in conjunction with the figures.

### BRIEF DESCRIPTION OF THE DRAWINGS

FIG. 1 is a cutaway illustration of the Mirabile engine as embodied in the present invention;

FIG. 2 is a cutaway cross section along the AA line of FIG. 1 showing how the shuttle valve operates;

FIG. 3 illustrates an exploded perspective view of both the combustion and compression chambers of FIGS. 1 and 2;

FIG. 4 depicts an exploded perspective view of the air intake system, including the compression piston, according to one embodiment of the present invention.

FIG. 5 illustrates an exploded view of how the engine block fits within the carrousel, in accordance with one embodiment of the invention;

FIG. 6 illustrates an exploded perspective view of the turbine piston as mated to the carrousel and armature with the race head being formed thereabout in accordance with one embodiment of the present invention;

FIG. 7 illustrates an alternative embodiment of the present invention;

FIG. 8 illustrates another embodiment of the present invention where multiple pistons are mated in a tandem design;

FIG. 9 is a schematic diagram of the air intake system in accordance with the present invention;

FIG. 10 illustrates another embodiment of the present invention where the drive piston is mated adjacent the compression piston with the combustion chamber moved outside the engine;

FIG. 11 illustrates an alternative embodiment where the combustion chamber is rotated 90 degrees relative to the compression chamber; and

FIG. 12 depicts a cutaway side view of a pivoting combustion chamber as embodied in the present invention.

### DETAILED DESCRIPTION OF SPECIFIC EMBODIMENTS OF THE INVENTION

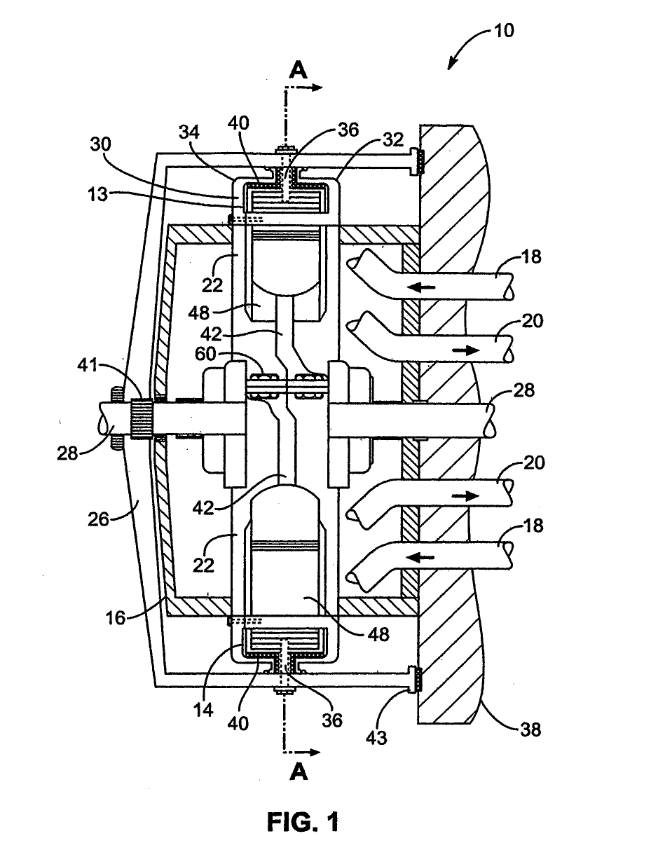

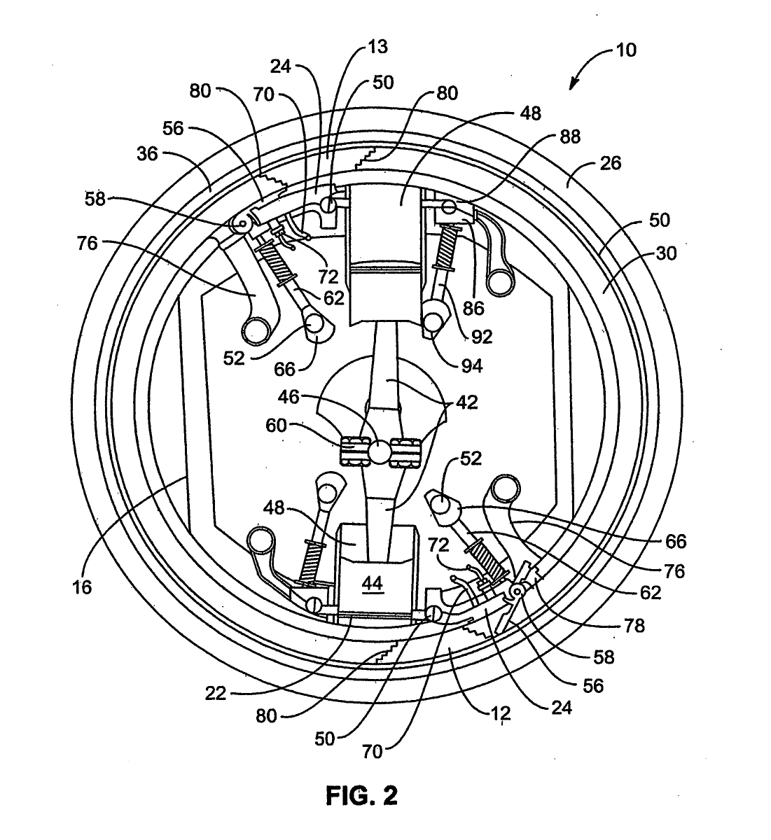

A novel engine is disclosed mat is an improvement over the prior art. Engine 10, known as the Mirabile Engine, is illustrated in FIGS. 1 and 2 and is a piston compressor, air chamber trap, turbine engine. Engine 10 includes a turbine piston 12, which rotates within a torroidal race head 14. Engine 10 further includes an engine block 16. Within engine block 16 is an air intake valve 18, an air exhaust valve 20, compression piston 22, and combustion chamber 24.

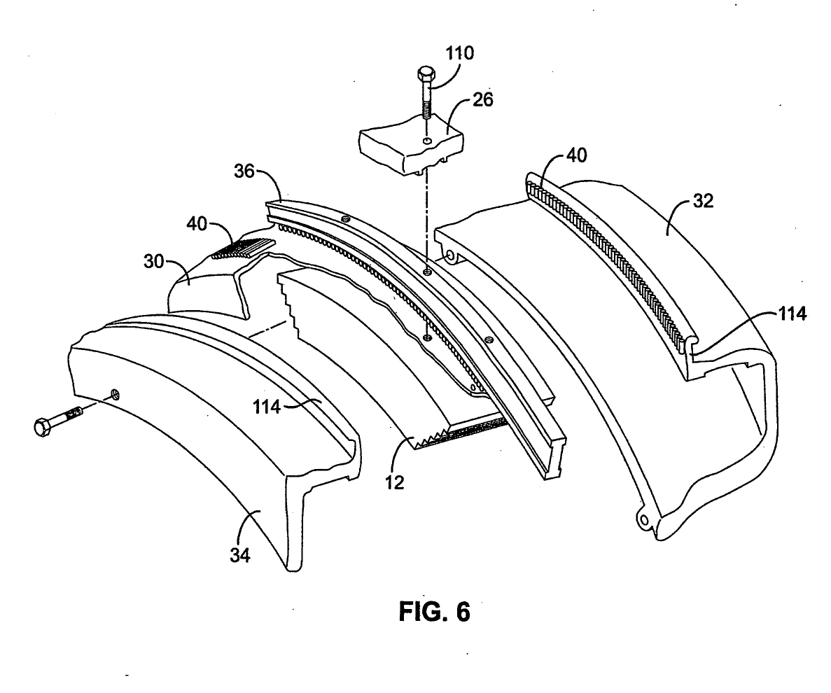

Engine 10 further comprises a carrousel member 26, to which torroidal race head 14 is mounted. Carrousel member 26 connects to a drive shaft 28. Race head 14 is formed by a torroidal head sleeve 30, which is comprised of a front torroidal race head 32 and a rear torroidal race head 34, which mate together to form the race or channel in which piston 12 operates. Piston 12 and race head 14 are shown in greater detail in FIGS. 2 and 6, along with FIG. 1. A torroidal head armature 36 mounts to race piston 12 and serves to guide race piston 12 within the race head 14. Carrousel 26 is further mounted to a carrousel mounting frame 38.

A dummy or opposing piston 13 is also mounted to armature 36 and is located radially opposite (i.e. 180 degrees opposite) that of drive piston 12. Piston 13 serves two important functions. The first function is that it acts as a counter balance to piston 12. This is important since the rotation speeds will be high enough that without the counterbalance, the engine would not work or it would vibrate severely enough to fail shortly after beginning operation. The second is that it serves to clear the chamber of exhaust gases after combustion and the energy from the combustion has been extracted by piston 12 used to turn carrousel 36 and drive shaft 28. Piston 13 sweeps along and trails piston 12 to clear the exhaust gases through exhaust vent 20.

Bearing tracks 40 are provided to allow piston 12 to travel within the race with reduced friction. Bearing tracks are located on either side of armature 36 as well as on race heads 32 and 34.

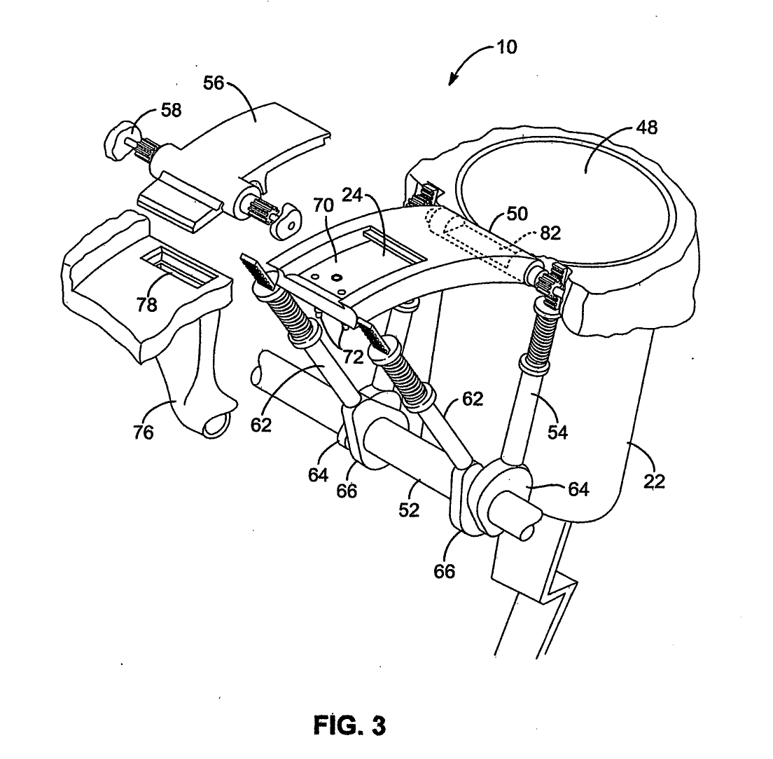

Piston 12 is shown further in FIG. 2, which is a cross sectional side view of engine 10 as illustrated in FIG. 1 and follows the dashed line marked at reference A; reference to the engine 10 is the same with respect to FIGS. 1 and 2. Compression piston 22 includes a piston shaft 42 connected to piston head 44. Shaft 42 connects piston head 44 to a crank shaft 46, which is part of drive shaft 28. Crank shaft 46 rotates so as to pump piston head 44 up and down within a piston chamber 48 to compress air within the chamber before the compressed air is delivered to combustion chamber 24. Separating piston chamber 48 from combustion chamber 24 is a shuttle valve 50, which is cam driven by cam shaft 52 and lifter rods 54. Operation of the cam drive assembly is illustrated in greater detail in FIG. 3.

Combustion chamber 24 is sealed during combustion by shuttle exhaust valve 56, which is hinged to move about a hinge 58. Hinge 58 is connected to a fixed portion of race sleeve 30 close to compression piston 22 and is mostly coplanar thereto. A second set of lifters 62 are provided to operate shuttle valve 50 during engine operation as driven by cam shaft 52. Cam shaft 52 is controlled by a timing mechanism (not shown), such as a gear or belt, or both, or other timing mechanisms well known to those skilled in the art, to time the compression and ignition of the fuel inside of combustion chamber 24 just prior to piston 12 passing over it in order to maximize fuel and power efficiency. Lobes mounted on cam shaft 52 operate to lift rods 54 and 62. Lobe set 64 operate lifter rods 54 and lobe set 66 operate lifter rods 62.

After piston 12 passes over exhaust valve 56, the valve opens (radially outward in this embodiment) to release the combusted air/fuel mixture mat is utilized to push piston 12 about the path. As piston 12 is driven, power is converted from the combustion event to mechanical motion as acted upon drive shaft 28, which can be coupled to a transmission system to control and optimize the power output from engine 10 for locomotive power or other types of energy conversion, i.e. electrical generators.

Turbine or torroidal piston 12 seals combustion chamber 24 when valve 50 drops in a closed position to seal compression piston chamber 48. Combustion chamber 24 and valve 56 form a generally cone or vee-shaped funnel that directs the combusted gases out of the chamber at a variable angle ranging from 5 to 45 degrees, with a range of 5 to 20 degrees being preferred. The angle ideally is set to be as close to perpendicular to the trailing edge of turbine piston 12 as possible, but since combustion chamber 24 is located within the body of the engine, and below turbine piston 12, complete perpendicularity to the trailing edge is not likely, but it is desired. Close perpendicularity is preferred because it acts upon turbine piston 12 in the same direction of travel, thereby increasing the momentum of travel and increasing torque during performance more efficiently man in other combustion engine designs. As the engine receives more fuel, the torque will increase as the engine turns higher revolutions per minute (rpm).

Fuel can be injected via several options. One method is to add the fuel to the air before entering piston chamber 48. Such a method is conventional with respect to gasoline powered engines, but is not limiting thereto. Another method, which is illustrated in FIGS. 2 and 3, is to inject fuel after compressing the air into combustion chamber 24. Fuel injector 70, as illustrated, injects fuel directly within combustion chamber 24. Fuel injector 70 atomizes the fuel in as fine as droplets as possible, which further optimizes combustion of the fuel in the compressed air environment.

Injection directly into the combustion chamber is especially appropriate in Diesel engine applications where high compressions can lead to premature ignition and delivering the fuel at the precise moment for ignition is preferred. Engine compression is directly related to efficiency and power output. Further, Diesel engines require greater compression during operation than do gasoline engines. Thus, the engine is designed robustly to accommodate the type of fuel utilized. Compression rates of 7:1 up to 12:1 are common in gasoline powered engines. Compression rates of 14:1 to 20:1 and higher are common in Diesel engines.

Fuel ignition is provided by a fuel igniter 72, which is also located to extend partially into combustion chamber 24. Fuel igniter 72 can be a sparkplug or a glowplug, depending upon the fuel type utilized. Recent improvements in sparkplug technology and computer controlled timing have reduced the need for sparkplug change and engine tuneups to in excess of 100,000 miles, their location for access are not as critical as in prior designs. Designs that provide ready access to the sparkplugs for replacement are left to the skilled artisan to implement. Multiple plugs may be utilized to improve burn efficiency.

Exhaust vent 76 is provided to exhaust the spent gases during operation. Exhaust vent 76 opens when valve 56 opens, but does not exhaust until piston 13 travels a sufficient enough distance to force the spent exhaust gases out through opening 78 in vent 76 when valve 32 opens. The exhaust gases are then voided from engine 10 utilizing vent 76 connected to manifolds, mufflers, and exhaust pipes well known to those skilled in the art.

Torroidal race piston 12 and dummy piston 13 are generally cylindrically wedge shaped having a radius for the top portion slightly smaller than that of the radius for the upper part of race 14 and a radius for the bottom portion slightly smaller than that of the radius for the lower path of the race. This arrangement allows the pistons 12, 13 to fit very precisely within the race so that any force applied to pistons 12, 13 by the combusted gas acts upon it as completely as possible rather than slip past the piston within the race thereby dissipating the force. Further, the leading and trailing surfaces are designed to mirror each other with a leading and trailing edge formed on the upper part of the piston tapering therefrom to the inner or bottom portion to form a trapezoidally shaped piston with a convex curvature on the top portion and a concave curvature on the bottom. The edges include steps 80 or they may be smooth. Steps 80 prevent the operation in a reverse direction when valve 56 is in the up or open position.

FIG. 3 illustrates an exploded perspective view of the compression and combustion assembly. Compression piston 22 includes compression chamber 48. Coupled to compression piston chamber 48 is combustion chamber 24. A compression valve 50 allows communication between compression piston chamber 48 and combustion chamber 24. Compression valve 50 is generally cylindrical in shape with a flat portion 82 on one surface. When in its resting position, flat portion 82 is oriented so that the pathway between the two chambers is closed. When compression valve 50 is rotated 90 degrees to its open position (shown in the ghosted portion), the pathway is opened between the two chambers. A pair of lifters 54 are placed oh either side to rotate compression valve 50 precisely at the right time to operate properly. Cam shaft 52, which is timed to the rotation of the race, lifts each lifter with lobe 64 placed on the shaft at the appropriate position. Springs 84 mount on each lifter 54 and serve to urge compression valve 50 in a closed position.

Air release or combustion valve 56 is mounted above combustion chamber 24 such that it can be moved into a sealing position via a second set of lifters 62, which are operated by the same cam shaft 52 via nodes or lobes 66. Exhaust port 76 is placed adjacent combustion valve 56 and is sealed by the valve via sealing tab 84 that fits precisely into exhaust opening 78. Exhaust gases are men exhausted through the exhaust system. Fuel injectors 70 are shown as being mounted in the fixed floor of the combustion chamber as is the ignition plug 72.

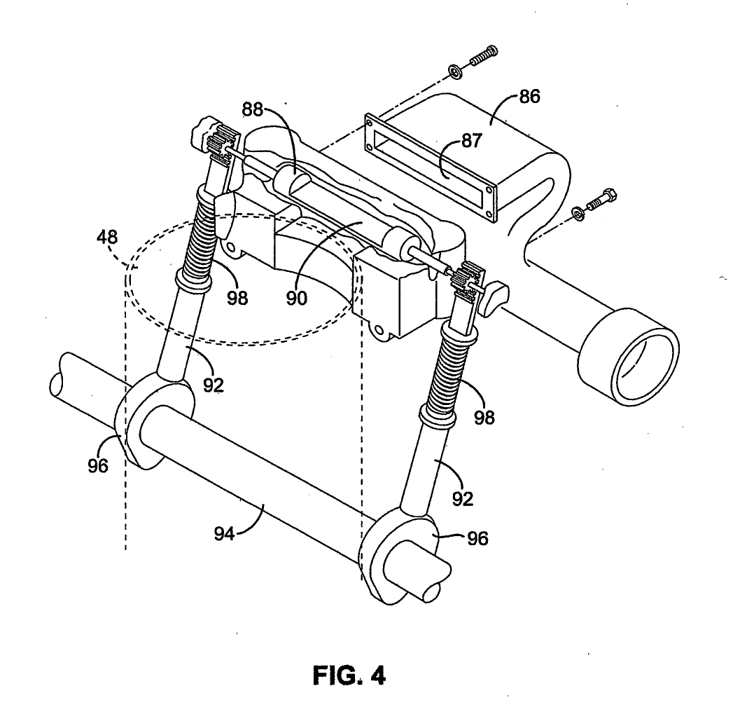

FIG. 4 depicts an exploded perspective view of compression piston 48 and air intake manifold 86. Intake manifold 86 is further connected to air intake 18 of FIGS. 1 and 2 and includes an air vent 87 through which air is fed from intake 18 into compression chamber 48. Compression chamber 48 is in ghost outline and has mounted adjacent it airflow valve 88, which is cylindrical in shape with a flat surface 90. A pair of airflow lifters 92 are placed on either side of valve 88 and operate to rotate it 90 degrees between a closed and open (shown) position. During the down stroke of operation, air is drawn from outside via air intake manifold 86 and valve 88 is rotated to an open position. The time is measured by how long it takes for compression piston 22 to travel from the up to the down position. At the bottom dead center position, which is when the compression chamber is at its largest volume, valve 88 closes as cam shaft 94 with lobes 96 turn valve 88 to its closed position. At this time compression piston 22 begins moving upward and compresses the air within the chamber into combustion chamber 24 for combustion. Lifters 92 include springs 98 to urge valve 88 into a resting closed position. The closed position prevents air from escaping once compression is completed and during combustion.

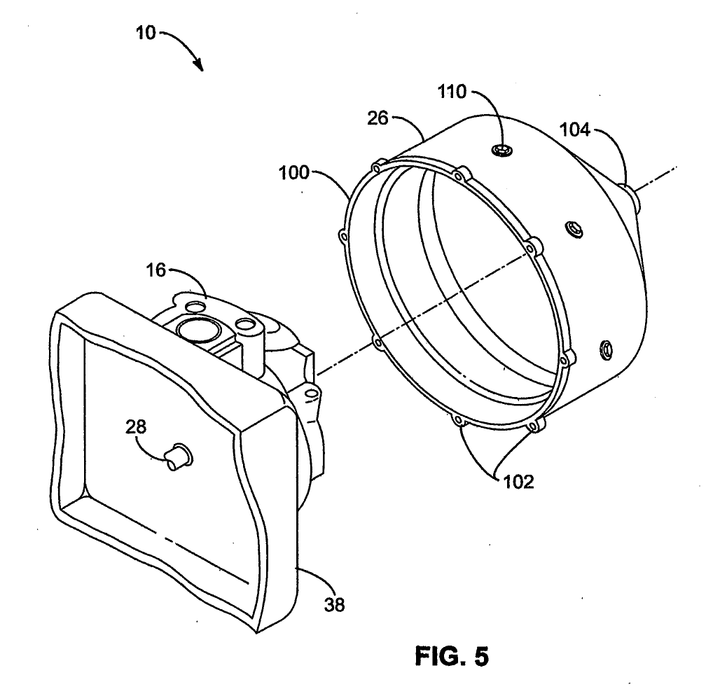

FIG. 5 depicts an exploded perspective view of engine 10. The main components include carrousel mounting frame 38 and carrousel torroidal head assembly 100. Engine block 16 fits within carrousel 26 snugly and is secured with bolts (not shown) through threaded openings 102. Assembly 100 fits over engine block 16 such that shaft 28 fits through opening 104 of carrousel 26.

FIG. 6 depicts an exploded cut-away view of torroidal race piston 12 as it fits inside torroidal race 14. Piston 12 attaches to torroidal armature 36 and torroidal sleeve 30 via securing bolt 110. Armature 36 further secures to carrousel 26 via the same bolt 110. It is this connection that allows the power generated by combustion to be transferred from piston 12 to carrousel 26, which then turns crank 28. Piston 12 fits within a race housing formed when front torroidal race head 32 mates to rear torroidal race head 34 and are secured in place by a series of bolts 112. Torroidal sleeve 30 and armature 36 slide within race sleeve 30 upon bearings 40, which are placed on the surface of torroidal sleeve 30 and upon a lip edge 114 of both torroidal race heads 32 and 34. In this embodiment, bearings 40 are cylindrical, but ball bearings and other type bearings are well within the art of the skilled engineer.

Turbine piston 12 is further connected to a turbine wheel or carrousel 26 as illustrated in FIG. 1. Turbine wheel 26 further connects to crank shaft 28. Turbine wheel 26 connects to crank shaft 28 via one or more keyed slot(s) 41, or other methods known to those skilled in the art. A set of bearings 42 are found on both sides of crank shaft 28 where compression piston 22 attaches to crank shaft 28. A bearing 43 is found on the edge of engine block 16 to allow shaft 28 to rotate.

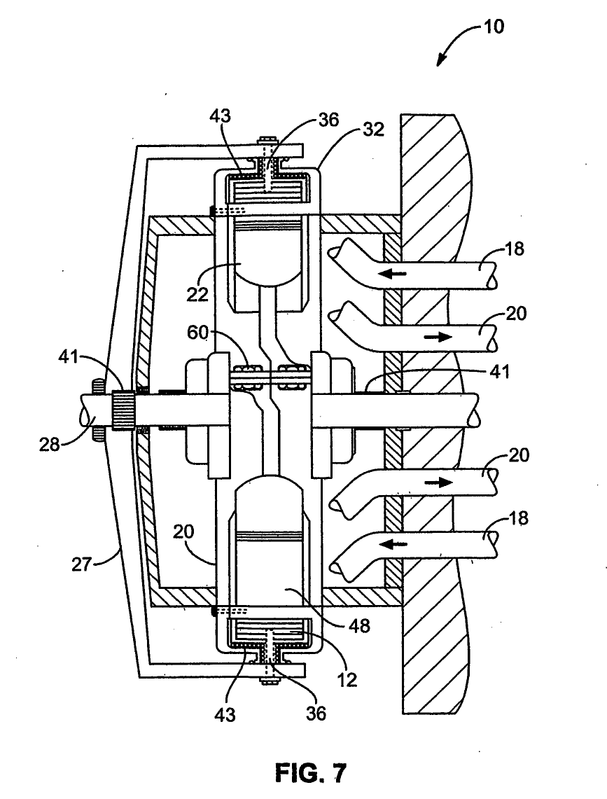

Carrousel 26 extends to the wall of carrousel mounting frame 38 to seal the assembly as is shown in the first embodiment of FIG. 1. Bearings 43 are placed between one edge of carrousel 26 and the surface of mounting frame 38 so that carrousel 26 can rotate against the mounting frame. In an alternative embodiment, as depicted in FIG. 7, carrousel 27 need not extend completely to the mounting frame, and instead, reaches only to torroidal head armature 36, where it is fixedly attached thereto. This reduces the overall mass of torroidal carrousel 27 and opens up the interior of engine 10 so that the service mechanic can have access to the spark plugs, fuel injectors and other mechanical elements typically serviceable during the life of the engine.

FIGS. 1 and 2 further depict two compression pistons top piston 22 and bottom piston 22; it matters not which piston is selected, but for purposes of this discussion, as one operates, the other operates in opposition, but also complementary. Compression pistons 22 and are located opposite one another in the same plane and are 180 degrees out of phase. Thus as the shaft 28 makes a half revolution, one compression piston 22 (top) will load an adjacent combustion chamber 24 (top) with air, or fuel or both, and combustion will occur. The other opposing compression piston 22 (bottom) will compress air, fuel or both within adjacent combustion chamber 24 (bottom) performing combustion during the second half revolution of the crank shaft. This provides two combustion events during the same cycle. This action results in a two cycle gasoline engine mat overcomes the limitations and drawbacks of the common two cycle engine. This results in twice as much power output as in a comparable four cycle engine having the same displacement. Further, rather than having the energy act downward on the piston head as is done in a conventional internal piston driven combustion engine, the force is directed in the same direction as the turbine piston, thus preventing much of the noise and violent motion of the piston having to reciprocate. This provides for smoother operation and less vibration during operation.

Although reciprocating compression piston 22 is utilized to compress the air and direct it into combustion chamber 24 prior to combustion, it is not acted upon directly by the expelling of combusted gases, thus minimizing the noise and vibration generated in prior art engine two and four cycle engines.

Piston shafts 24 are formed to be offset when coupled to crank shaft 28. They include a holding end 60 that encircle a portion of crank shaft 28. Oil or other lubricants are utilized to reduce or eliminate friction during engine operation. The oil lubricates all metal on metal contacts that move against each other, such as the piston shafts 24 and the crank shaft 28, the piston 20 moving within compression chamber, the turbine piston 12 moving along piston race 14, and the crank shaft bearings 42.

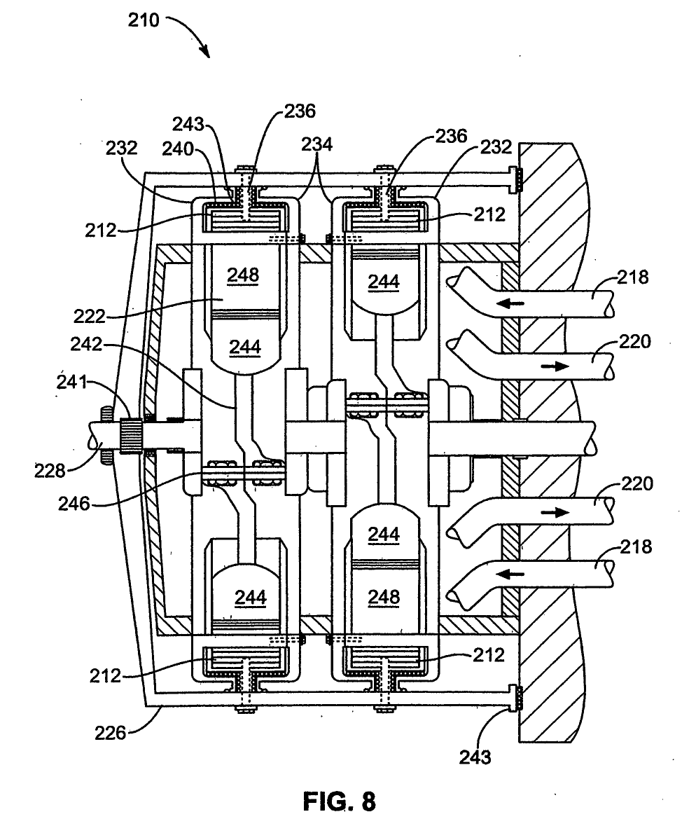

One significance of the present invention is that additional compression chambers and combustion chambers can be placed radially about the camshaft, thereby increasing power within the same space. Since turbine piston 12 is basically cylindrical and travels about a circular path, as many combustion chambers and compression chambers as is practical can be connected to it. Although a minimum of one combustion chamber is necessary, ideally, each chamber will have an opposing chamber mounted 180 degrees opposite the first Third and fourth chambers can be added as pairs, with each opposing the other. The symmetry of the opposing pistons minimizes vibration and noise during operation. FIG. 8 depicts an engine 210 that includes a second set of turbine pistons 212 and combustion chambers in tandem to one another

Engine 210 includes a plurality of combustion chambers (not shown), but similarly illustrated in FIGS. 2 and 3. The combustion chambers are filled by compression pistons 222, which include compression piston head 244 fitted within compression chamber 248. Head 244 is driven by drive shaft 228 as connected to the head via piston shaft 242 at connection 246. Carrousel 226 is Coupled to torroidal armature 236, which is further coupled to pistons 212 and is driven thereby as has been described earlier. Carrousel 226 can extend to mounting frame 238 and rotate against it on bearings 243, or the carrousel can end just by the first set of pistons on the right side similar to the embodiment of FIG. 7. Each set of pistons includes front torroidal race head 232 and rear torroidal race head 234 mated together like that shown in FIG. 6. Armature 236 rotates about bearing track 240, which includes bearings 243.

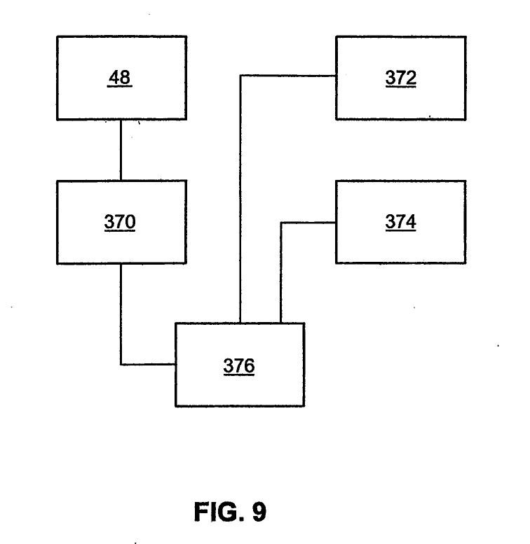

Air intake is drawn through a filtering system 370, shown in the schematic diagram of FIG. 9, and is conventional within the art Air is received from filtering system 370 and then can be compressed via either a turbo charger 372 or a super charger 374 (only one is utilized or provided with the engine and which is a matter of preference of the designer, both have their advantages and disadvantages) prior to entering the compression chamber 48. An air intercooler 376 can also be utilized to reduce the temperature of the air after being compressed via the turbo charger 372 or super charger 374. Cooler air is denser than warm air, thus increasing the air to fuel ratio to provide greater performance and efficiency during operation.

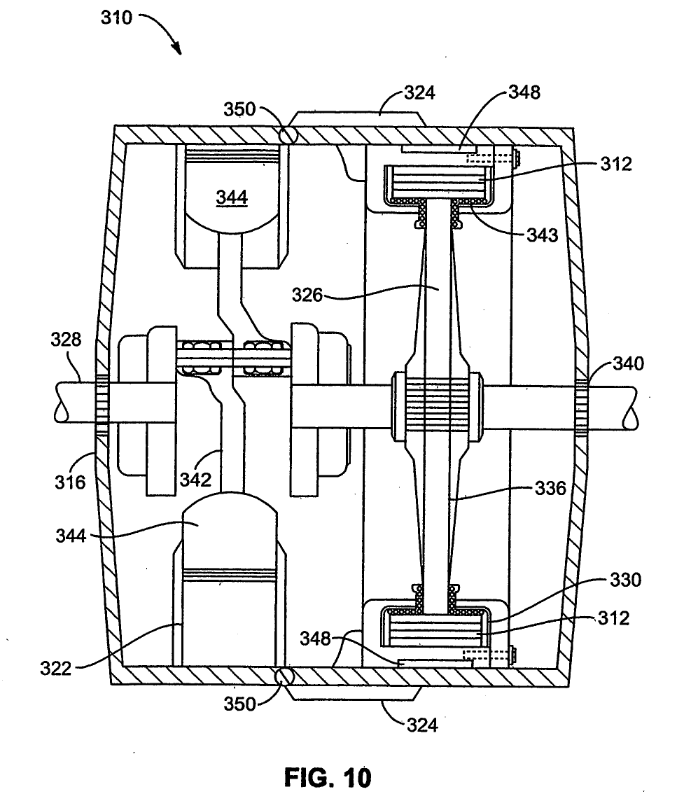

FIG. 10 illustrates yet another alternative embodiment. In this example, engine 310 places piston turbine 312 adjacent to compression chambers 322. Combustion chamber 324 is directly above carrousel or piston turbine 326. Carrousel or piston turbine 326 is no longer formed in a half-shell design like that of FIG. 1. In this embodiment, piston turbine 326 is more spoke like or paddle wheel like in design. A torroidal race sleeve 330 serves as the guide for race head piston 312. Piston 312 connects to a shaft or torroidal head armature 336, which is further connected to drive shaft or crank 328. Air is drawn in via compression piston 322; the piston 322 compresses the air into combustion chamber 324 which is located outside of engine block 316. Shuttle valve 350 moves to block the compressed air from returning back within compression chamber 324. Combustion then occurs with fuel mixed within the combustion chamber 324 and the exploded gas expels through combustion valve 348 against turbine piston 312. This embodiment removes the need to time the action of the shuttle valve 350 from being in the path of the turbine piston 312 as found in the first embodiment. Shaft 328 turns on bearings 340 during operation. Race head or turbine piston 312 turns on bearings 343 during operation, as previously described. Bearings 340 and 343 are cylindrical in shape, but can be ball bearings in alternative embodiments. Such design and implementation is within the skill of a typical artisan.

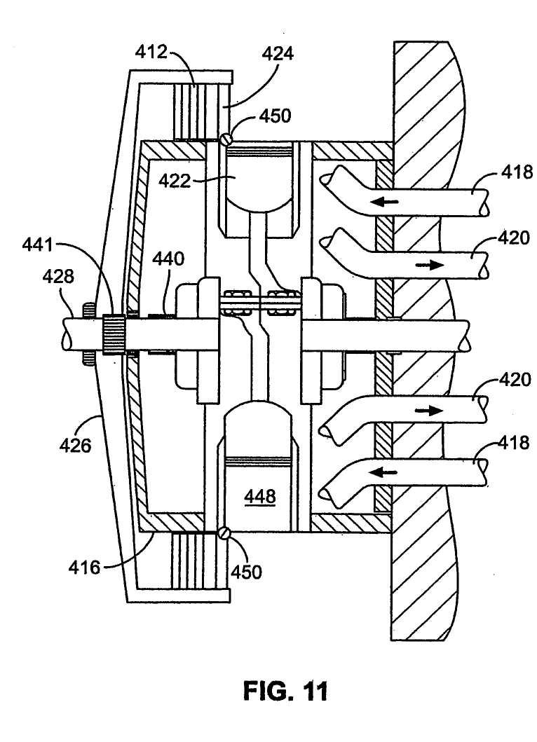

In an alternative embodiment shown in FIG. 11, combustion chamber 424 is shifted 90 degrees from the first design. Compression piston 422 draws air in through intake valve 450, which is moved 90 degrees as well. Compression piston 422 remains in its original orientation. Valve 450 seals the chamber when piston 422 is at TDC. Combustion occurs and the exhaust moves outward against turbine piston 412. The exhaust gas is directed at the appropriate angle to push turbine piston 412 in a constant direction to turn carrousel 426. Carrousel 426 is locked to crank shaft 428 and turns it as piston 412 moves. 426 rotates upon bearing 440 between turbine piston 412 and engine block 416. Intake air is delivered via air intake 418 and exhaust is directed through exhaust port 420. The operation of the engine operates in the same manner as those described above in the other embodiments.

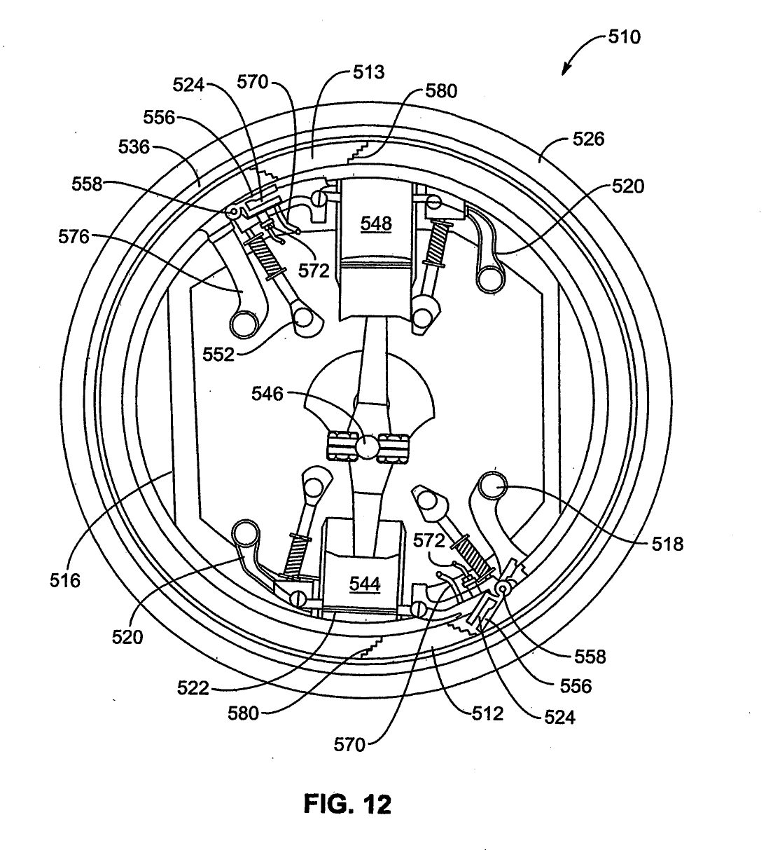

FIG. 12 illustrates another embodiment of the present invention where the combustion chamber is a unitary unit that pivots upward into the race to increase energy conversion from a release of combustion chemical energy to mechanical energy. Engine 510 includes a turbine piston 512, which rotates within a torroidal race head 514. Engine 510 further includes an engine block 516. Within engine block 516 is an air intake valve 518, an air exhaust valve 520, compression piston 522, and combustion chamber 524.

Engine 510 further comprises a carrousel member 526, to which torroidal race head 514 is mounted. Carrousel member 526 connects to a drive shaft 528. Race head 514 is formed by a torroidal head sleeve 530, which is comprised of a front torroidal race head 532 and a rear torroidal race head 534, which mate together to form the race or channel in which piston 512 operates. Piston 512 and race head 514 are identical to those shown in greater detail in FIGS. 2 and 3, along with the present figure. A torroidal head armature 536 mounts to race piston 512 and serves to guide race piston 512 within the race head 514. Carrousel 526 is further mounted to a carrousel mounting frame 538. It should be noted that carrousel member 526 is part of engine block 516.

A dummy or opposing piston 513 is also mounted to armature 536 and is located diametrically opposite (i.e. 180 degrees opposite) that of drive piston 512. Piston 513 serves two important functions. The first function is that it acts as a counter balance to piston 512. This is important since the rotation speeds will be high enough that without the counterbalance, the engine would not work or it would vibrate severely enough to fail shortly after beginning operation. The second is that it serves to clear the chamber of exhaust gases after combustion and the energy from the combustion has been extracted by piston 512 used to turn carrousel 536 and drive shaft 528. Piston 513 sweeps along and trails piston 512 to clear the exhaust gases through exhaust vent 520. Fuel is provide via fuel injector 570 and is ignited via ignitor 572.

Combustion chamber 524 is a unitary chamber with the walls, ceiling, and floor are fixed together so that the chamber as a whole rotates about a pivot during operation. Chamber 524 is sealed during combustion by shuttle exhaust valve 556, which is hinged to move about a hinge 558. Hinge 558 is connected to a fixed portion of race sleeve 530 close to compression piston 522 and is mostly coplanar thereto. A second set of lifters are provided to operate shuttle valve during engine operation as driven by cam shaft 552, as described with respect to the embodiments of FIGS. 1-5. Cam shaft 552 is controlled by a timing mechanism (not shown), such as a gear or belt, or both, or other timing mechanisms well known to those skilled in the art, to time the compression and ignition of the fuel inside of combustion chamber 524 just prior to piston 512 passing over it in order to maximize fuel and power efficiency.

After piston 512 passes over exhaust valve 556, the valve opens (radially outward in this embodiment) to release the combusted ah/fuel mixture that is utilized to push piston 512 about the path. As piston 512 is driven, power is converted from the combustion event to mechanical motion as acted upon drive shaft 528, which can be coupled to a transmission system to control and optimize the power output from engine 510 for locomotive power or other types of energy conversion, i.e. electrical generators.

Turbine or torroidal piston 512 seals combustion chamber 524 when the chamber drops in a closed position to seal compression piston chamber 48. Combustion chamber 524 is generally rectangular and applies the force more directly to the back edge of piston 512 during operation as it rises into the race path as shown in FIG. 12.

In review, The Mirabile Engine is a horizontally opposed reciprocating compressor (H.O.R.C.) torroidal piston engine. Air feeds to the HORC piston via an intake manifold. The piston compresses the air so as to feed it into a separate air compression chamber. The chamber captures the air where it is mixed with fuel and ignited for combustion to turn the torroidal piston. Combustion takes place when the air release and exhaust valves spring up to top out on the torroidal sleeve just behind the face of the torroidal piston. This drives the torroidal piston around the torroidal race head. While the air release and exhaust valve is up, exhaust is driven out by the secondary or dummy torroidal piston placed 180 degrees opposite the real torroidal piston. The air release valve and exhaust valve is constructed as a unitary element. The air release valve acts as a backstop for the combustion to drive the torroidal piston forward in a manner similar to that of a conventional reciprocating piston head design. The exhaust half of the valve unseats at the exact same time letting out the exhaust gas.

The same sequence occurs 180 degrees later. This provides a 2-cycle engine, which operates twice as often as that as a conventional 4-cycle engine combustion engine. Combustion does not take place in the reciprocating compressor as is required in the conventional combustion engine, but rather, it takes place only in the torroidal head, when the compressed air that was transferred from the reciprocating compressor to the separate combustion chamber is released with fuel and ignition fired when the air release and exhaust valve is topped out on the torroidal sleeve or the separate movable separate air chamber is topped out on the sleeve. This and other details are highlighted in greater detail as described above and illustrated in the figures.

Thus, a genuine two cycle engine is disclosed. With one rotation of the active torroidal piston and the counterbalance or dummy piston, combustion and exhaust occurs within one cycle.

At high speeds, the compression step can be achieved via ramjet action. The air can compress just from the speed of the vehicle moving through the atmosphere. This simplifies the action of the engine and generates more power because the crank shaft would no longer need to turn the compression pistons. A hybrid engine would be designed to eliminate the need for the compression pistons. In such an embodiment, a clutch or transmission system would be utilized to engage and disengage the compression pistons from being driven by the crank shaft. Or, a separate engine mat operates using ramjet principles would be included to take over once sufficient velocity is achieved.

The Mirable engine is intended to be a universal application engine. Since it is a two cycle engine, it can be utilized in two cycle applications such as for motorcycles, snowmobiles, recreational boat engines, among others. Further, the Mirable engine can be constructed to operate in long use applications such as in power plants, heavy construction equipment, semi trucks, locomotive engines, and sea going vessels. Further more, the Mirable engine can be utilized in aircraft since it provides a greater power output than conventional four cycle engines. Additionally, the Mirable engine can be utilized in passenger automobiles, such as cars and trucks, buses, and heavy trucks.

Those skilled in the art having the benefit of the present teachings as set forth herein above may effect numerous modifications thereto. These modifications may be construed as falling within the scope of the present invention as set forth in the appended claims.

1. A combustion engine comprising:
an air intake;
an air compressor, coupled to the air intake;
a combustion chamber, coupled to the air compressor;
a shuttle valve, placed between the air compressor and the combustion chamber, to seal off the combustion chamber from the air compressor during combustion;
a fuel supplier, coupled to the air compressor and the combustion chamber, that delivers fuel to the air after intake to provide a fuel/air mixture that has been compressed within the combustion chamber;
a crank shaft, rotatably coupled to the air compressor, that operates the air compressor and to transfer power generated by the engine to a useful purpose;
a turbine piston, coaxially coupled to the crank shaft, that travels in a circular path and is adjacent to the combustion chamber and serves to seal the combustion chamber during combustion of an air/fuel mixture and passes over the combustion chamber allowing the combustion chamber to open wherein the turbine piston is driven by a force generated by combustion of the fuel/air mixture within the combustion chamber as the combusted fuel/air mixture exits and is directed against the turbine piston to rotate the turbine piston and turn the crank shaft.

2. The combustion engine according to claim 1 wherein the air compressor is a reciprocating piston within a compression chamber that draws air through the air intake and compresses the air into the combustion chamber separate from the compression chamber.

3. The combustion engine according to claim 2 herein the fuel is injected into the compression chamber prior to compression.

4. The combustion engine according to claim 2 wherein the fuel is injected into the combustion chamber prior to combustion occurs.

5. The combustion engine according to claim 1 further comprising an ignitor within the combustion chamber to ignite the fuel/air mixture at a fixed time to combust the fuel/air mixture therein.

6. The combustion engine according to claim 5 wherein the ignitor is a spark plug having a spark end located within the combustion chamber.

7. A method of deriving power within a combustion engine having a turbine piston comprising the steps of:
A intaking air;
B compressing the intake air within a first compression chamber using a compression piston;
C shuttling the compressed air to a first combustion chamber separate from the compression chamber;
D injecting fuel within the intake air;
E sealing the first combustion chamber from the first compression chamber;
F sealing the first combustion chamber with a portion of the turbine piston as it rotates about a piston head race adjacent the first combustion chamber;
G igniting the compressed fuel/air mixture within the sealed first combustion chamber to combust the fuel/air mixture;
H removing the turbine piston seal, allowing the combusted fuel/air gases to escape towards the turbine piston and impart its moment on the turbine piston increasing its rotation momentum;
I repeating steps A-H thereby deriving power from the combustion events within the first combustion chamber.

8. The method according to claim 7 wherein the combustion engine operates as a two cycle engine.

9. The method according to claim 7 wherein a second compression chamber and second combustion chamber are located on an opposite side of the path of the turbine piston as compared to the first compression chamber and second combustion chamber such that steps A-H as performed by the second compression chamber and second combustion chamber operate 180 degrees out of phase of steps A-H as performed by the first compression chamber and the first combustion chamber resulting in two combustion events per revolution of the turbine piston.

10. The method according to claim 7 wherein the turbine piston is connected to a crank shaft, which is further coupled to the compression piston to perform the compression step further comprising the step of transferring power from the turbine piston to the crank shaft.

11. A combustion engine comprising:
an air intake;
an air compressor, coupled to the air intake;
a movable combustion chamber, coupled to the air compressor;
a shuttle valve, placed between the air compressor and the combustion chamber, to seal off the combustion chamber from the air compressor during combustion;
a fuel supplier, coupled to the air compressor and the combustion chamber, that delivers fuel to the air after intake to provide a fuel/air mixture that has been compressed within the combustion chamber;
a crank shaft, rotatably coupled to the air compressor, that operates the air compressor and to transfer power generated by the engine to a useful purpose;
a turbine piston, coaxially coupled to the crank shaft, that travels in a circular path and is adjacent to the combustion chamber and serves to seal the combustion chamber during combustion of an air/fuel mixture and passes over the combustion chamber allowing the combustion chamber to move and direct a release of the combusted air/fuel mixture to drive the turbine piston thereby rotating the turbine piston and turn the crank shaft, which converts the force of the combustion into mechanical energy.

12. The combustion engine according to claim 11 wherein the air compressor is a reciprocating piston within a compression chamber that draws air through the air intake and compresses the air into the combustion chamber separate from the compression chamber.

13. The combustion engine according to claim 12 herein the fuel is injected into the compression chamber prior to compression.

14. The combustion engine according to claim 12 wherein the fuel is injected into the combustion chamber prior to combustion occurs.

15. The combustion engine according to claim 11 further comprising an ignitor within the combustion chamber to ignite the fuel/air mixture at a fixed time to combust the fuel/air mixture therein.

16. The combustion engine according to claim 15 wherein the ignitor is a spark plug having a spark end located within the combustion chamber.

17. The combustion engine according to claim 11 further comprising an intake shuttle valve placed between the compression chamber and the air intake to seal the compression chamber from the air intake during compression of the air drawn in through the air intake.

18. The combustion engine according to claim 11 further comprising:
a second air intake;
a second air compressor, coupled to the second air intake;
a second combustion chamber, coupled to the second air compressor, the fuel supplier, and located opposite the combustion chamber;
a second shuttle valve, placed between the second air compressor and the second combustion chamber, to seal off the second combustion chamber from the second air compressor during combustion;
a second turbine piston, coaxially coupled to the crank shaft in tandem to the turbine piston and traveling in a circular path, the second turbine piston seals the second combustion chamber during combustion of an air/fuel mixture and passes over the second combustion chamber allowing the second combustion chamber to open wherein the second turbine piston is driven by a force generated by combustion of the fuel/air mixture within the second combustion chamber as the combusted fuel/air mixture exits and is directed against the second turbine piston to rotate the second turbine piston and turn the crank shaft.

19. The combustion engine according to claim 11 further comprising a sweep turbine piston, coupled to the crank shaft and mounted diametrically opposed to the turbine piston to sweep out the spent combusted gases within the engine after the energy has been extracted mere from.

20. The combustion engine according to claim 11 wherein the turbine piston is generally wedge shaped with an inner surface having a radius of curvature generally equal to that of a lower path surface in which the turbine piston travels and an outer surface having a radius of curvature generally equal to that of an upper path surface in which the turbine piston travels.
